(19) United States
(12) Patent Application Publication
(10) Pub. No.: US 2009/0101106 A1
(43) Pub. Date: Apr. 23, 2009

(54) METHOD OF CONTROLLING HEATING DURING IDLING OF VEHICLE

(76) Inventor: Ji Hyun Moon, Jeonju-si (KR)

Correspondence Address: MORGAN, LEWIS & BOCKIUS LLP (SF), One Market, Spear Street Tower, Suite 2800, San Francisco, CA, 94105, US

(21) Appl. No.: 11/967,481

(22) Filed: Dec. 31, 2007

(30) Foreign Application Priority Data
Oct. 22, 2007 (KR) 10-2007-0106199
Nov. 27, 2007 (KR) 10-2007-0121501

(51) Int. Cl. F02D 45/00

(52) U.S. Cl. 123/339.22

(57) ABSTRACT

A method of controlling heating while a vehicle is idling is disclosed. The method comprises: determining whether a state of readiness for idle heating exists; determining whether the vehicle is slopped; determining whether a temperature outside the vehicle reaches a winter temperature; and thereby operating an idle heating mode when all above criteria are met.

### CROSS-REFERENCE TO RELATED APPLICATIONS

This application claims priority to Korean Application No. 10-2007-0121501, filed on Nov. 27, 2007, the disclosure of which is incorporated herein by reference.

### BACKGROUND OF THE INVENTION

1. Field of the Invention

The present invention relates to a method of controlling heating while a vehicle is idling, more particularly, a method of controlling heating while a vehicle is idling, capable of improving heating performance without an auxiliary heater during the idling.

2. Description of the Prior Art

In general, while a vehicle having an automatic transmission travels during the winter season, the vehicle having the automatic transmission has low heating performance in an idle stale due to a reduction in the operational performance of a heater.

For example, when the vehicle travels with the heater turned on for about 30 minutes in the state in which the temperature outside the vehicle is low, and then is left in an idle state, the revolutions per minute (rpm) of the engine thereof fall below a target rpm (e.g. 700 rpm), even though the temperature of cooling water is already raised. Hence, the operational performance of the heater, associated with the driving force of the engine, can be lowered.

In order to solve this problem, the lack of heat source is overcome using an auxiliary heater, such as a positive temperature coefficient (PTC) heater. However, this auxiliary heater, such as the PLC heater, is expensive, and thus the use thereof is restricted.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Accordingly, the present invention has been made keeping in mind the above problems occurring in the prior art, and an object of the present invention is to provide a method of controlling heating while a vehicle is idling, capable of improving healing performance while idling without an auxiliary heater during the idling.

In order to achieve the above object, according to the present invention, there is provided a method of controlling heating while a vehicle is idling. The method comprises the steps of: checking whether a key switch is in an ON state and whether an idle heating switch for idle heating is in an ON state, and thereby determining whether a state of readiness for idle heating exists; checking whether a gearshift is maintained in a neutral state, whether an accelerator is being operated, and whether a speed of the vehicle is within a range from a first preset speed to a second preset speed, and thereby determining whether the vehicle is slopped; checking whether a temperature outside the vehicle is within a range from a first preset outside temperature to a second preset outside temperature and/or whether a cooling water temperature is within a range from a first preset cooling water temperature to a second preset cooling water temperature, and thereby determining whether a temperature outside the vehicle reaches a winter temperature; and operating an idle healing mode when all above criteria are met.

Further, the idle heating mode is operated; if the key switch is in an ON stale and the idle healing switch for idle heating is in an ON state; if the gearshift is maintained in a neutral state, the accelerator is not being operated; if the speed of the vehicle is increasing and within the range from the first preset speed to the second preset speed; and if the temperature outside the vehicle is equal to or less than the first preset outside temperature or, is increasing and within the range from the first preset outside temperature to the second preset outside temperature and/or the cooling water temperature is equal to or less than the first preset cooling temperature, or is increasing and within the range from the first preset cooling water temperature to the second preset cooling water temperature.

The first preset speed is about 2 km/h and the second preset speed is about 5 km/h; the first preset outside temperature is about 5° C. and the second preset outside temperature is about 8° C.; and the first preset cooling water temperature is about 60° C. and the second preset cooling water temperature is about 70° C. and at the idle heating mode, a number of revolutions per minute (rpm) of an engine is increased to about 900 rpm, and an exhaust brake is forcibly operated.

According to the present invention, when prescribed conditions are met, the vehicle using a diesel engine enhances the rpm of the engine to increase the flow rate of the engine and a cooling water temperature, and forcibly operates the exhaust brake in order to increase the load on the engine, so that the amount of heat emitted from the engine can be increased.

Further, the present invention can improve the idle healing performance to a satisfactory level without using an auxiliary heater, so that it has an economic advantage in that an expensive apparatus such as a PTC heater is not used.

### BRIEF DESCRIPTION OF THE DRAWINGS

The above and other features of the present invention will now be described in detail with reference to certain exemplary embodiments thereof illustrated the accompanying drawings which are given hereinbelow by way of illustration, and thus are not limitative of the present invention, and wherein:

FIG. 1 is a schematic block diagram illustrating the configuration used for a method of controlling heating while a vehicle is idling according to an exemplary embodiment of the invention; and

FIG. 2 is a block diagram illustrating the logic used for a method of controlling heating while a vehicle is idling according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to a preferred embodiment of the present invention, an example of which is illustrated in the accompanying drawings and described below. While the invention will be described in conjunction with an exemplary embodiment, it should be understood that the description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

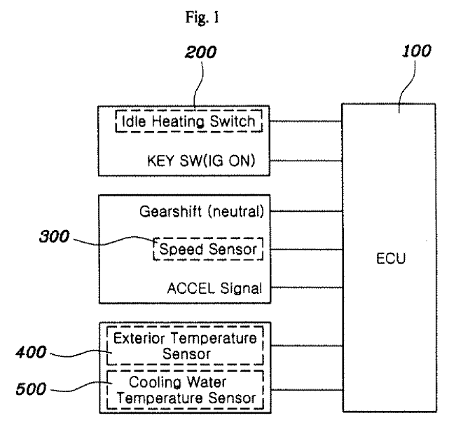

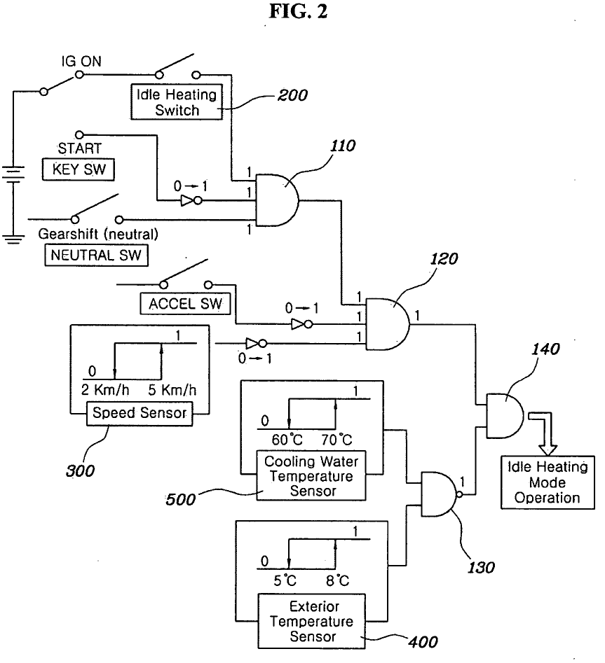

As illustrated in FIGS. 1 and 2 an exemplary embodiment of the present invention comprises a process of determining whether a state of readiness for heating while a vehicle is idling (hereinafter, referred to as “idle heating”) exists, a process of determining whether the vehicle is stopped, a process of determining whether the temperature outside the vehicle has reached a winter temperature, and a process of operating an idle heating mode.

To this end, the present invention, as an exemplary embodiment of the present invention, comprises an idle heating switch 200 for idle heating, a speed sensor 300 for detecting the speed of the vehicle, an exterior temperature sensor 400 for measuring the temperature outside the vehicle, and a cooling water temperature sensor 500 for measuring the temperature of cooling water. Further, the exemplary embodiment comprises an electrical control unit (ECU) 100 for operating the idle heating mode when the data received from these sensors meets preset conditions.

More specifically, in the process of determining whether a state of readiness for idle heating exists, the status of whether the idle heating switch 200 for idle heating is turned on is checked after a key switch is turned on.

At this time, if the key switch is turned on and the idle healing switch is turned on, the ECU 100 determines that the electrical conditions for idle heating are met, and that the preparations for the idle heating are completed.

In the process of determining whether the vehicle is stopped, the ECU 100 checks the neutral state of the gearshift, the non-operation of the accelerator, and the predetermined range of the vehicle speed. That is, the ECU 100 cheeks that a gearshift is maintained in a neutral state, that an accelerator (pedal) is operated by means of an accelerator switch, and that the vehicle speed is increasing and within a range from 2 km/h to 5 km/h, or is equal to or less than 2 km/h, by means of the speed sensor 300.

When these conditions of the neutral slate of the gearshift the non-operation of the accelerator, and the predetermined range of the vehicle speed, arc met the ECU 100 determines that the vehicle is stopped.

In the process of determining that the temperature outside the vehicle has reached winter temperature, the ECU 100 monitors, using the exterior temperature sensor 400, whether the exterior temperature is equal to or less than 5° C. or is increasing and within a range from 5° C. to 8° C., and further the ECU 100 monitors, using the cooling water temperature sensor 500, whether the cooling water temperature is equal to or less than 60° C. or is increasing and within a range from 60° C. to 70° C. When either one of the conditions of the exterior temperature and the cooling water temperature is met, the ECU 100 determines that the temperature outside the vehicle has reached winter temperature.

Thereafter, when all the conditions of the processes are met, the ECU 100 operates an idle heating mode.

In the process of operating an idle heating mode, the number of revolutions per minute (rpm) of an engine is increased to about 900 rpm, and an exhaust brake is forcibly operated.

This increased rpm of the engine improves the operating force of the heater associated with the driving force of the engine. “The operation of the exhaust brake causes a shutter to be closed through the operation of an exhaust actuator, so that the quantity of injected fuel can be increased through the increase in the amount of engine load, and so that the amount of heat emitted from the engine can be increased to the range from about 7% to about 10%.

Next, the control logic for operating an idle heating mode will be described hereinafter in detail.

FIG. 2 is a block diagram illustrating the logic used for a method of controlling heating while a vehicle is idling according to an exemplary embodiment of the preset invention.

When the key switch for a power supply is in an IGNITION ON state and when the idle heating switch 200 is in an ON state, a logic value of “1” is transmitted to a first logical AND operator 110. When the key switch is in a START stale, the logic value of “1” is transmitted to the first logical AND operator 110. When the gearshift is in a NEUTRAL state, the logic value of 1 is transmitted to the first logical AND operator 110.

In contrast when the idle heating switch 200 is not in the ON state or the gearshift is not in the NEUTRAL state, the logic value of “1” is not transmitted to the first logical AND operator 110 and thus neither to a second logical AND operator 120 nor to a third logical AND operator 140. As a result, the idle heating mode is released.

Subsequently, when the accelerator is not operated, the logic value of “1” is transmitted to the second logical AND operator 120. When the vehicle speed measured by the speed sensor 300 is increasing and within a range from 2 km/h to 5 km/h or, is equal to or less than 2 km/h, the logic value of “1” is transmitted to the second logical AND operator 120.

However, when the accelerator is operated, or when the vehicle speed is decreasing and within a range from 5 km/h to 2 km/h or, is equal to or more than 5 km/h, the logic value of “1” is transmitted neither to the second logical AND operator 120, nor to a third logical AND operator 140. Thus, the idle heating mode is released.

Continuously, when the cooling water temperature measured by the cooling water temperature sensor 500 is equal to or less than 60° C. or is increasing and within a range from 60° C. to 70° C. a logic value of “0” is transmitted to a logical NAND operator 130. When the exterior temperature measured by the exterior temperature sensor 400 is equal to or less than 5° C. or is increasing and within a range from 5° C. to 8° C., the logic value of 0 is transmitted to the logical NAND operator 130. If these two conditions or any one of them is met, the logical NAND operator outputs “1.”

At this time, when the cooling water temperature is equal to or greater than 70° C., or is decreasing and within a range from 70° C. to 60° C., and when the exterior temperature is equal to or greater than 8° C., or is decreasing and within a range from 8° C. to 5° C., the logic value of “1” is transmitted to the logical NAND operator 130 and thereby the logic value output by the logical NAND operator 130 is “0”. Thus, the idle heating mode is released.

In other words, when the value output by the third logical AND operator 140 via the first logical AND operator 110, the second logical AND operator 120, and the logical NAND operator 130 is equal to a logic value of “1” the ECU 100 increases the engine rpm to about 900 rpm, and forcibly operates the exhaust brake, so that the heating performance can be improved without using a separate pre-heater.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of controlling heating while a vehicle is idling, comprising the steps of:
checking whether a key switch is in an ON state and whether an idle heating switch for idle heating is in an ON stale, and thereby determining whether a state of readiness for idle heating exists;
checking whether a gearshift is maintained in a neutral state, whether an accelerator is being operated, and whether a speed of the vehicle is within a range from a first preset speed to a second preset speed, and thereby determining whether the vehicle is slopped;
checking whether a temperature outside the vehicle is within a range from a first preset outside temperature to a second preset outside temperature and/or whether a cooling water temperature is within a range from a first preset cooling water temperature to a second preset cooling water temperature, and thereby determining whether a temperature outside the vehicle reaches a winter temperature; and
operating an idle heating mode when all above criteria are met.

2. The method according to claim 1, wherein the idle heating mode is operated:
if the key switch is in mi ON slate and the idle heating switch for idle heating is in an ON state; and
if the gearshift is maintained in a neutral state, the accelerator is not being operated; and
if the speed of the vehicle is increasing and within the range from the first preset speed to the second preset speed; and
if the temperature outside the vehicle is equal to or less than the first preset outside temperature, or is increasing and within the range from the first preset outside temperature to the second preset outside temperature and/or the cooling water temperature is equal to or less than the first preset cooling temperature, or is increasing and within the range from the first preset cooling water temperature to the second preset cooling water temperature.

3. The method according to claim 1 or 2, wherein
the first preset speed is about 2 km/h and the second preset speed is about 5 km/h;
the first preset outside temperature is about 5° C. and the second preset outside temperature is about 8° C.; and
the first preset cooling water temperature is about 60° C. and the second preset cooling water temperature is about 70° C.

4. The method according to claim 1, wherein at the idle heating mode, a number of revolutions per minute (rpm) of an engine is increased to about 900 rpm, and an exhaust brake is forcibly operated.
